(19) United States
(12) Patent Application Publication
(10) Pub. No.: US 2019/0197278 A1
(43) Pub. Date: Jun. 27, 2019

(54) SYSTEMS, COMPUTER READABLE MEDIA, AND METHODS FOR RETRIEVING INFORMATION FROM AN ENCODED FOOD LABEL

(71) Applicant: Genista Biosciences Inc., San Jose, CA (US)

(72) Inventors: Arun Kastury, San Jose, CA (US); Kiran Kastury, San Jose, CA (US)

(21) Appl. No.: 16/219,768

(22) Filed: Dec. 13, 2018

Related U.S. Application Data
(60) Provisional application No. 62/598,077, filed on Dec. 13, 2017.

(51) Int. Cl. G06K 7/14; G06K 19/06; G06F 16/903; G06Q 30/06

(52) U.S. Cl. CPC G06K 7/1447; G06K 7/1443; G06Q 30/0627; G06K 19/06178; G06F 16/90335; G06K 19/06103

(57) ABSTRACT

An image of a food label affixed to a food item may be received. The food label may be encoded with an optical code that is associated with the food item. The code may be encoded into the food label via optical elements that are not visible to an unassisted human eye. The image may be of sufficient resolution to capture the optical elements present in the food label. The image may be analyzed to detect the optical elements and determine the code using the detected optical elements. A query including the code may then be generated and communicated to a database so that the database is queried for information regarding the food item that is associated with the code. The requested information may be received and provided to a display device.

### RELATED APPLICATION

This application is a NON-PROVISIONAL application of and claims priority to U.S. Provisional Patent Application No. 62/598,077 filed on Dec. 13, 2017 and entitled “METHODS AND SYSTEMS FOR RETRIEVING INFORMATION FROM AN ENCODED FOOD LABEL,” which is incorporated herein by reference in its entirety.

### FIELD OF THE INVENTION

The present invention relates to retrieving information from a label associated with, and/or affixed to, a food item. The label may be embedded with information regarding the food item and/or a link to information regarding the food item. Often times, the embedded information is readable to a machine but imperceptible to the human eye.

### BACKGROUND

Today, consumers are becoming increasingly more curious and attentive when making their food choices as knowledge of the health benefits as well as the adverse effects of certain food choices and/or food processing methods is becoming more widespread. Traditional food labels, while beneficial, fail to capture much of the information that could potentially be presented to consumers.

### SUMMARY

Disclosed herein are systems, non-transitory machine-readable medium, and methods for retrieving information from an encoded food label. The systems may execute a method including receiving an image of a food label affixed to a food item. The food label may be encoded with a code that is associated with the food item. The code may be encoded into the food label via optical elements that are not visible to an unassisted human eye and the image may be of sufficient resolution to capture the optical elements. In some embodiments, the food label includes a graphic, a logo, text, and/or an image and the optical elements may be embedded within the a graphic, a logo, text, and/or an image.

The image may be analyzed to detect the optical elements and determine, or otherwise resolve, the code using the detected optical elements. The code may be, for example, a binary code or an alpha-numeric code. A query including the code may be generated.

Then, a database storing food information may be queried for information regarding the food item that is associated with the code using the generated query. In some instances, in the database is populated and maintained by a third party not associated with the sale, distribution, or manufacturing of the food item. The third party may also independently verify some, or all, of the information associated with the food item that is stored in the database.

Information regarding the food item associated with the code may then be received from the database responsively to the query. In some embodiments, the information regarding the food item includes information regarding an assessment of food item safety, a description of health impacts of the food item, a description of a production method of the food item, a description of a manufacturing process for the food item, and a description of a source of the food item. At times, a portion of the information stored in the database may pertain to the safety as may be determined by, for example, microbial testing, testing for contaminants, and/or allergen testing of the food item may be verified by a third-party entity that is not involved with the sale, distribution, or manufacturing of the food item such as a food safety testing facility, a certification agency, a food safety auditor, etc. The food safety information may pertain to a test for biological contamination of the food item and chemical contamination of the food item.

Then, the received information may be provided to a display device for display to a user. Often times, the display device is a display screen of a portable computing device like a smart phone or a tablet computer. The information may be displayed as one or more user interfaces that may include user-selectable elements (e.g., icons, dropdown menus, etc.).

In some embodiments, a user may select a category of information associated with the food item via, for example, selection of a graphic element or icon provided by a user interface. In these embodiments, the querying and the information provided to the user is responsive to the selected category of information. For example, if the user selects the category of traceability then, the query of the database may specifically request information regarding the traceability of the food item and/or ingredients included in the food item.

In one embodiment, the user may request information regarding a geographic location for a source of the food item and then the database may be queried for that information. The geographic location for the source and a geographic location of a user may be received. The geographic location of the user may be received via, for example, use of a Global Positioning System (GPS) component located within the portable computing device of the user and/or triangulation of the portable computing device using Wi-Fi or cell phone towers the portable computing device may be in communication with. Then, a distance between the geographic location for the source and the geographic location of the user may be determined and provided to the display device. Exemplary manners of providing the distance to the display device include provision of an alpha-numeric information (e.g., 27 miles) and/or display of a distance between two icons (one representing the geographic location of the user and one representing the geographic location of the source. When a food item includes multiple ingredients (e.g., strawberries and bananas), the geographic location for each of these sources may be determined and then a distance between the first and second sources may be determined.

Additionally, or alternatively, a map of geographic region (e.g., North America, North and South America, entire globe, etc.) may be received. In some instances, the map may be received responsively to a query of a map database including a plurality of geographic maps, the query including a geographic location of the source of the food item (or an ingredient included therein) and the geographic location of the user. Then, a first graphic element (e.g., icon) for display on the map showing the geographic location of the source of the food item and a second graphic element for display on the map showing the geographic location of the user may be generated and added to the map. Provision of a graphic display of the map to the display device may then be facilitated. In some embodiments, the icon may be user-selectable so that when selected (via, e.g., touching a location of a touch screen corresponding to where the icon is displayed), additional information about, for example, the food item, ingredient, production facility, manufacturing facility, process of manufacturing and/or process of distribution may be provided to the display device.

In some embodiments, a user may provide one or more user preferences, requirements, or limitations regarding the food he or she wants to consume. The user preference may be provided at any time (e.g., during set up of the software application that provides instructions for executing the method, when the user is using the software application to obtain information about a food item and/or food ingredient, etc.). In some instances, one or more instructions for how the user preference is to be applied may be received. For example, if a user does not like peanuts, then the user may communicate a preference not to eat peanuts when the flavor of peanuts may be detected (i.e., when the peanuts are not a relatively flavorless ingredient as may occur when machinery used to process peanuts is used to process something else). However, if a user has an allergy to peanuts, then the user may communicate a preference not to eat peanuts or any foods that may be contaminated by trace amounts of peanuts at any time. The user preference may also indicate how he or she wishes to be made aware of food items and/or ingredients that apply to the user preference. Then, it may be determined how the user preference applies to the information received from the database. This determination may be binary (e.g., the preference does or does not apply) and/or graduated on a scale of, for example, 1-10. Then, provision of the determination to the display device may be facilitated via, for example, providing information in a graphic user interface displayed by the display device.

In some cases, the user preference may pertain to a food allergy and provision of the determination may include provision of a warning responsively to a determination that the information received from the database indicates that the food item may include and/or be contaminated by the food allergen.

In another embodiment, a request for information regarding a set of multiple food items, wherein each food item in the set of food items is the same. Such a request may come from, for example, a bulk purchaser of food items, a food safety auditor, and/or a distributer. This step is not always performed. An image of a food label associated with a set of food items may be received. Each food item in the set of food items is the same. The food label may be encoded with a code that is associated with the set of food items, the code being encoded into the food label via optical elements that are not visible to an unassisted human eye. The image may be of sufficient resolution to capture the optical elements. At times, the food label may be attached to the set of food items (e.g., on the packaging for the set). The food label may be encoded with an optical code that is associated with the set of food items. The optical code may then be decoded.

A database may then be queried for information associated with at least one of the decoded optical code and the set of food items associated with the decoded optical code. The queried-for information regarding the set of food items from the database may then be received and provided to a display device so that they may be communicated to a user.

In some cases, the set of food items may be manufactured by a single manufacturer, packaged by a single packager, and/or distributed by a single distributer.

In some embodiments, the information queried for and received is scientific information compliant with various technical standards regarding, for example, specific testing protocols used and/or performed to assess the safety of the food items within the set of food items.

### BRIEF DESCRIPTION OF THE DRAWINGS

FIG. 1 depicts a system for retrieving food information from an encoded food label, in accordance with one embodiment of the invention.

FIG. 2A depicts a food item with an encoded food label, in accordance with one embodiment of the invention.

FIG. 2B depicts an encoded food label, in accordance with one embodiment of the invention.

FIG. 3A depicts a screenshot of a landing page (e.g., a user interface that may be displayed upon the launch of a software application), in accordance with one embodiment of the invention.

FIG. 3B depicts a screenshot of a user interface for capturing an image of an encoded food label, in accordance with one embodiment of the invention.

FIG. 3C depicts a screenshot of the default-landing page displaying information regarding the safety associated with the food item, that consists of a user interface for displaying an identity of the food item as well as categories of food information (e.g., safety, health, facility, traceability) in accordance with one embodiment of the invention.

FIG. 3D depicts a screenshot of user interfaces for displaying information regarding the safety associated with the food item, in accordance with one embodiment of the invention.

FIGS. 3E-31 depicts a screenshot of a user interface for displaying information regarding the health benefits and/or adverse effects of consuming the food item, in accordance with one embodiment of the invention.

FIGS. 3H-3N depict screenshots of user interfaces for displaying information regarding a production process of the food item, in accordance with one embodiment of the invention.

FIGS. 3O-3Q depict screenshots of user interfaces for displaying information regarding a source (e.g., location of farm) of the food item, in accordance with one embodiment of the invention.

FIG. 4 depicts a flowchart of a process for retrieving food information from an encoded food label, in accordance with one embodiment of the invention.

FIG. 5 depicts a flowchart of a process for determining a measure of how well a food item satisfies a food preference, in accordance with one embodiment of the invention.

FIG. 6 depicts components of a computer system in which computer readable instructions instantiating the methods of the present invention may be stored and executed.

### DETAILED DESCRIPTION

In the following detailed description, reference is made to the accompanying drawings that form a part hereof, and in which are shown by way of illustration specific embodiments in which the invention may be practiced. It is understood that other embodiments may be utilized and structural changes may be made without departing from the scope of the present invention. Description associated with any one of the figures may be applied to a different figure containing like or similar components/steps. While the flow diagrams each present a series of steps in a certain order, the order of the steps is for one embodiment and it is understood that the order of steps may be different for other embodiments.

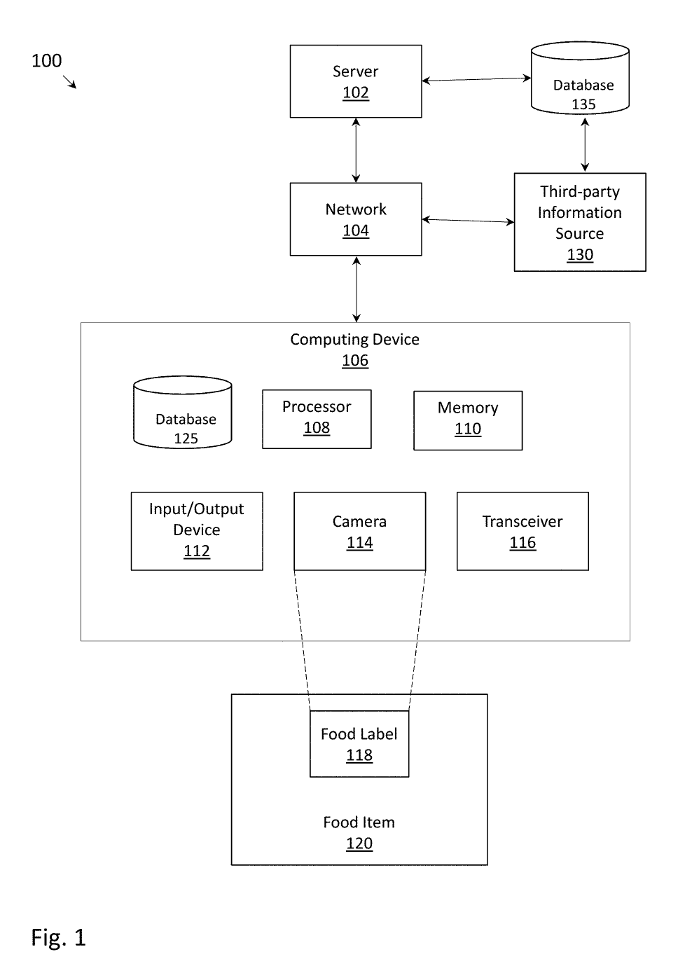

FIG. 1 depicts system 100 for retrieving food information from encoded food label 118, in accordance with one embodiment of the invention. System 100 may include computing device 106. In some embodiments, computing device 106 may be a mobile computing device, such as a smart phone or a tablet computer. In other embodiments, computing device 106 may be a desktop computer, a kiosk in a grocery market, or a smart refrigerator. Computer device 106 may include camera 114 (or other image capturing device) for capturing an image of food label 118 disposed on food item 120. Camera 114 may be configured to capture images of food label 118 of sufficient resolution that the image captures features of food label 118 that are not visible to the human eye (e.g., 1 mm-0.001 mm in width).

Encoded within food label 118 may be a code (e.g., a binary digital number, an alphanumeric string, etc.). In one embodiment, food label 118 may include one or more graphic elements including, but not limited to, an image, a company logo, an alphanumeric string, and a phrase (e.g., “eat safe. verified.”) that are readable (or perceptible) to a human. In some instances, the contents of food label 118 may indicate compliance with one or more food safety, production protocols, and/or manufacturing protocols. For example, a seal of confidence such as “ESV” may convey to the user that the food item was made in accordance with strict guidelines regarding, for example, safety, health, facilities, and/or traceability.

The code encoded within food label 118 may be present as one or more optical elements printed and/or encoded (e.g., embedded as a bitmap or barcode) in a portion of the food label 118 (e.g., as part of the graphic content and/or white space of the label) in a fashion that is imperceptible, or nearly imperceptible, to the human (e.g., width of an optical encoded element of 1 mm-0.01 mm), but readable by computing device 106 provided that camera 114 captures an image of food label 118 that is of sufficient resolution. One example coding technique is DWCode™ from GS1™ of Brussels, Belgium. Another example coding technique is that from Digimarc Corporation™ of Beaverton, Oreg.

Among the benefits of a food label encoded in such a manner is that it may be more aesthetically pleasing than other forms of computer-readable codes, such as a conventional barcode or QR code. As such, food label 118 may be located in a highly visible location of food item 120 (e.g., next to brand name of food item), rather than in a less visible location (e.g., bottom side of container), as is often the case for a barcode or QR code.

In one embodiment, food label 118 may be adhered to, or affixed onto, food item 120 (e.g., food label 118 in the form of a sticker). For instance, food item 120 may be a piece of fruit, and food label 118 could be a sticker that is adhered onto the piece of fruit. Additionally, or alternatively, food label 118 may be directly printed onto food item 120 and/or positioned near a food item 120 (e.g., on a sign or catalog associated with the food item). For instance, food item 120 may be a package of spaghetti, and food label 118 may be printed onto the package of spaghetti. If not already apparent, it is noted that food item 120 may refer to an item that can be eaten or more generally, may refer to the combination of the food item together with its packaging (e.g., a cup of yogurt). Additionally, or alternatively, a food label 118 may refer to a plurality, or set, of food items 120.

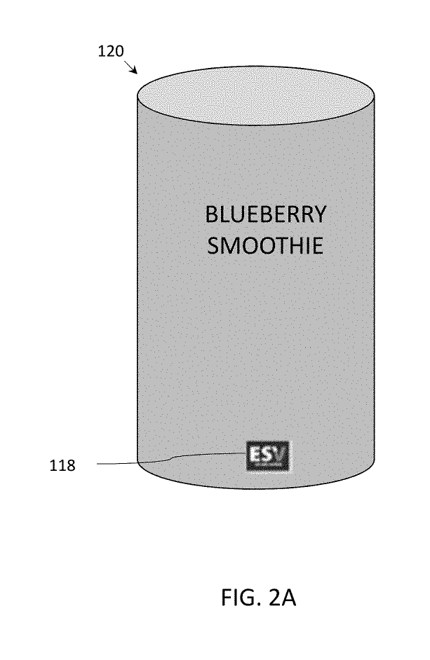

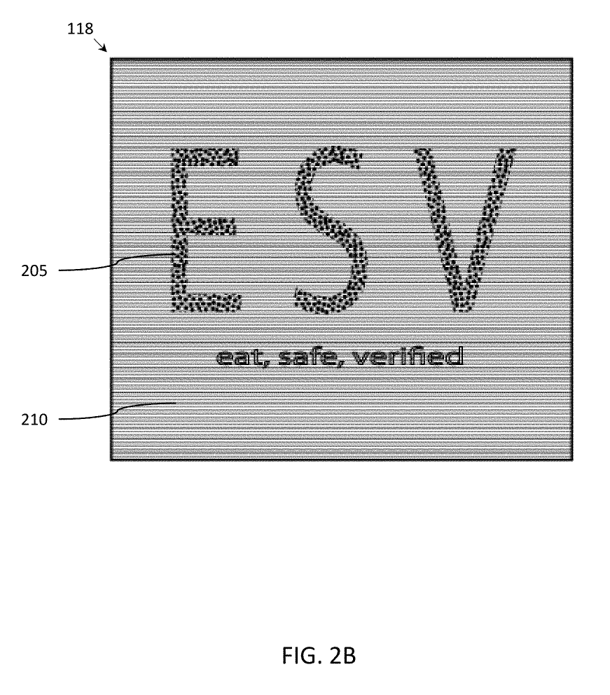

An example of food label 118 and food item 120 is depicted in FIG. 2A. In FIG. 2A, food label 118 is printed on a container of blueberry smoothie (i.e., the food item 120). While the instant application is primarily focused on labels for food items (e.g., bread, cereal, fruits, nuts, grains, meat, shellfish, alcohol, juices, dairy products, vitamins, etc.), it is understood that the concepts described herein could be easily applied to items other than food item (e.g., consumable items such as cosmetics, shampoo, toothpaste, or wearable items such as clothing, jewelry, watches, etc.).

FIG. 2B provides an example of optical elements that may be embedded into food label 118 that provide encoded information. The exemplary food label 118 of FIG. 2B shows a first type of optical elements 205 that are embedded into the logo “ESV” and a second type of optical elements 210 that are embedded into background of food label 118. The optical elements 205 and 210 may be small in width and/or length and/or circumference so that they are imperceptible to the human eye. Any combination of shapes may be used as optical elements 205 and/or 210. In some cases, a food label 118 may only include optical elements 205 or 210.

System 100 may include a server 102 communicatively coupled to a database 135. Information included in database 135 may be sourced from a variety of entities and sources including, but not limited to, food manufactures, food distributers, food sellers, food testers, food safety auditors, trade publications, federal and state agencies (e.g., FDA), and independent third-party food quality and/or safety testing bodies to determine food items they meet safety and/or quality requirements. This information is aggregated by server 102 and may be served to computing device 106 via network 104. In some instances, a code and/or arrangement of optical elements which represent a code for a particular food item may be indexed to corresponding food information by server 102 and this index is also stored in database 135. In some embodiments, information, such as nutrition information, information about potential benefits of food items and/or ingredients may be stored in database 135.

Third-party information source 130 may be any source of information not directly related to the production, manufacturing, distribution, or sale of the food items (e.g., food testers, food safety auditors, trade publications, federal and state agencies (e.g., FDA).

Computing device 106 may further include a database 125 of food information that may be populated, updated, and/or maintained by, for example, server 102 and/or third-party information source 130. Database 125 may include, for example, the index of codes and associated food items as well as some, or all, of the food information stored in database 135. More specifics regarding information that may be stored in database 125 and/or database 135 may be found in the discussions provided herein. For example, all of the information displayed via the user interfaces discussed herein may be accessed and queried from database 125 and/or database 135.

Computing device 106 may also include an input/output device 112 (e.g., touch-screen display) configured to operate camera 114 and accept instructions from a user, and/or provide information (e.g., graphic elements, images, text, etc.) to the user. Upon an image of food label 118 being captured by camera 114, computing device 106 (specifically, processor 108 executing instructions stored on memory 110) may determine (e.g., extract) the code that is encoded within food label 118. One example decoding technique that may be used to extract the code from food label 118 is the DWCode™. Once the code has been determined, transceiver 116 may transmit a request to server 102 requesting the food information associated with the code. Alternatively, computing device 106 may query the user as to the type of food information that is desired before transmitting the request with the code to server 102. If not already apparent, computing device 106 may be communicatively coupled to server 102 via network 104, in which network 104 may be a wired and/or wireless network, a public and/or private network, LAN, MAN, WAN, etc. In another embodiment (not depicted), a database of food information may be locally stored on computing device 106, and in such a configuration, computing device may retrieve the food information associated with food label 118 without communicating with server 102.

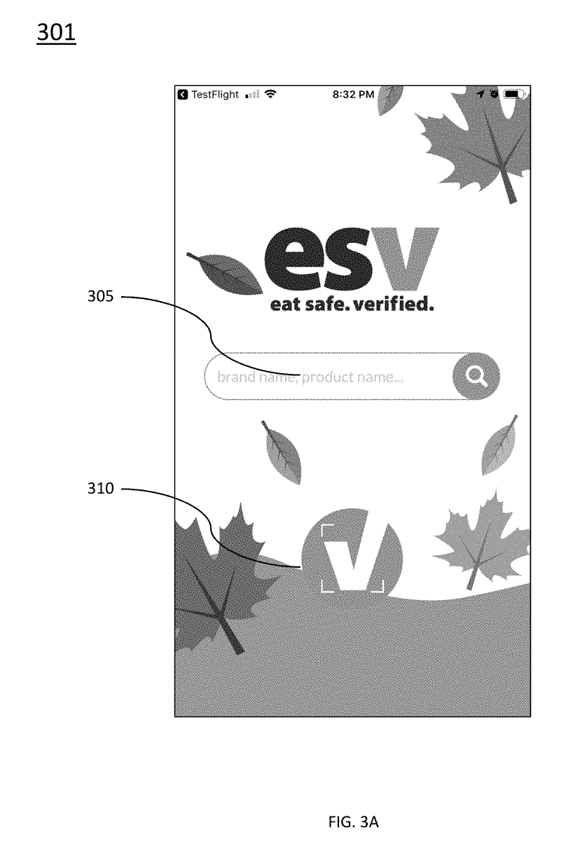

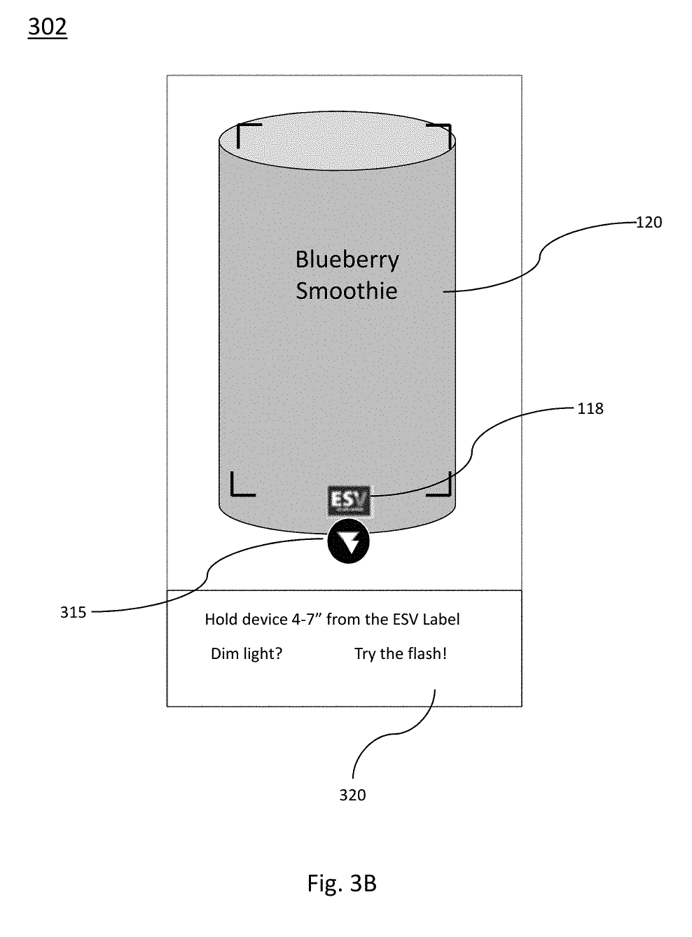

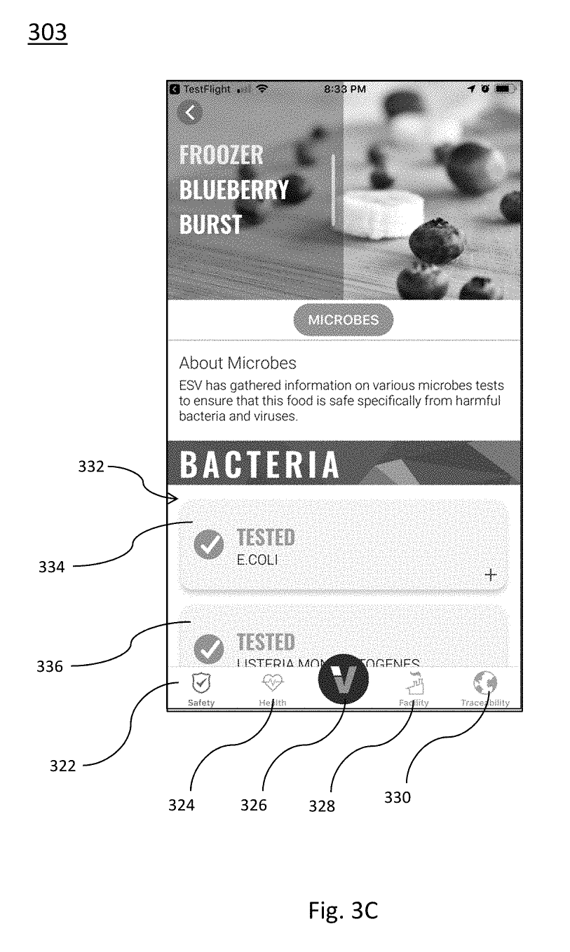

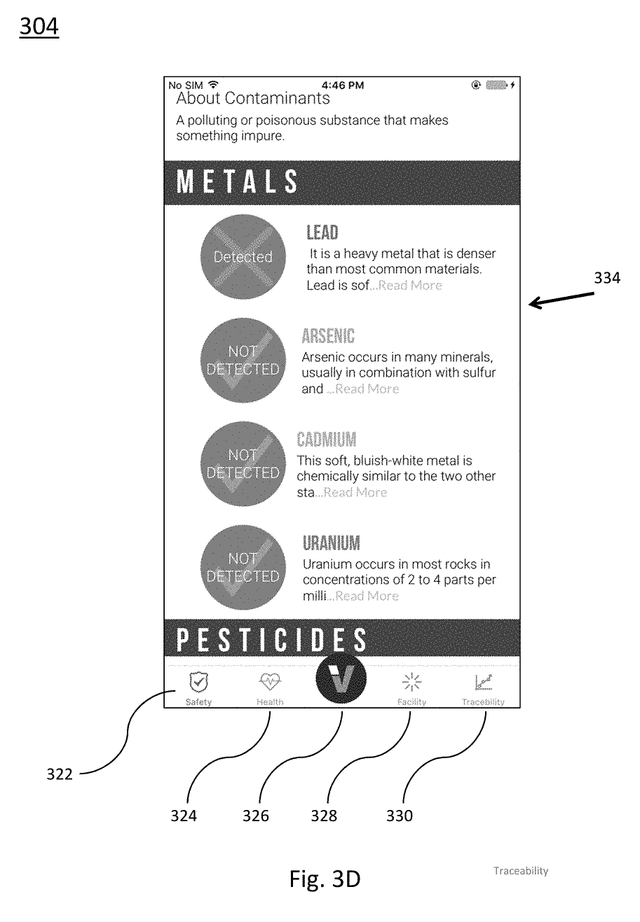

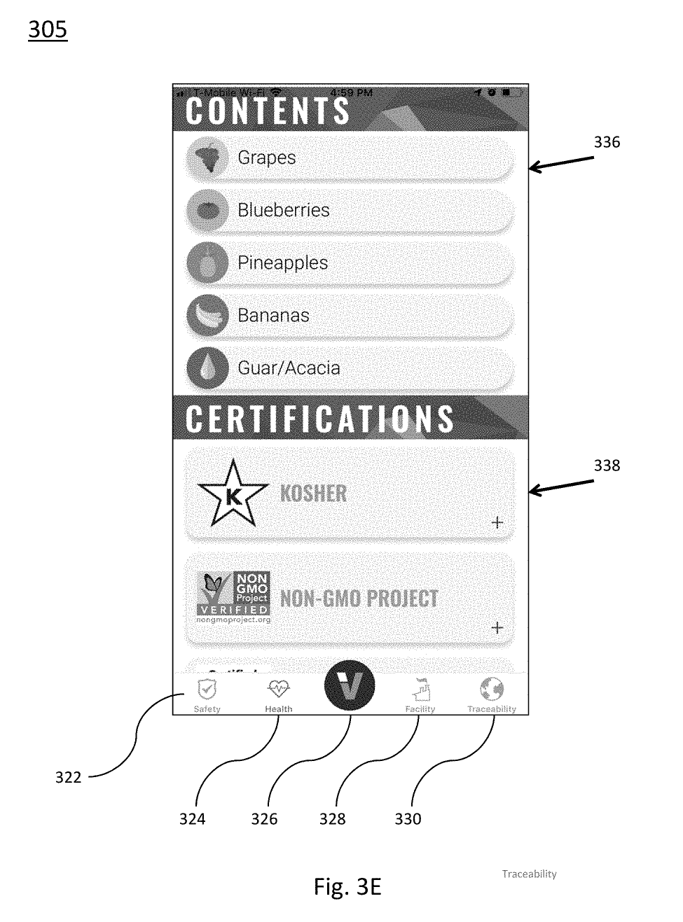

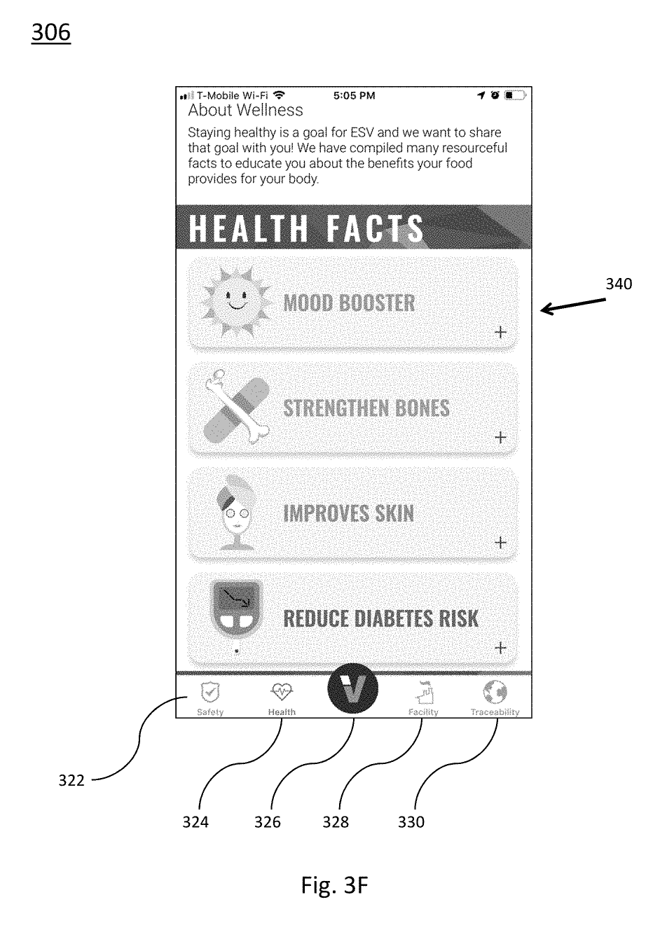

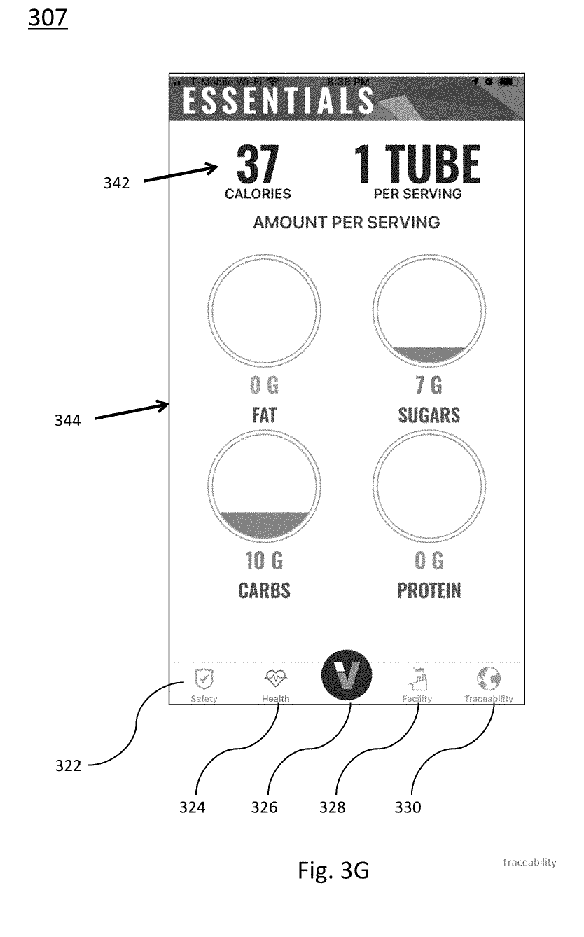

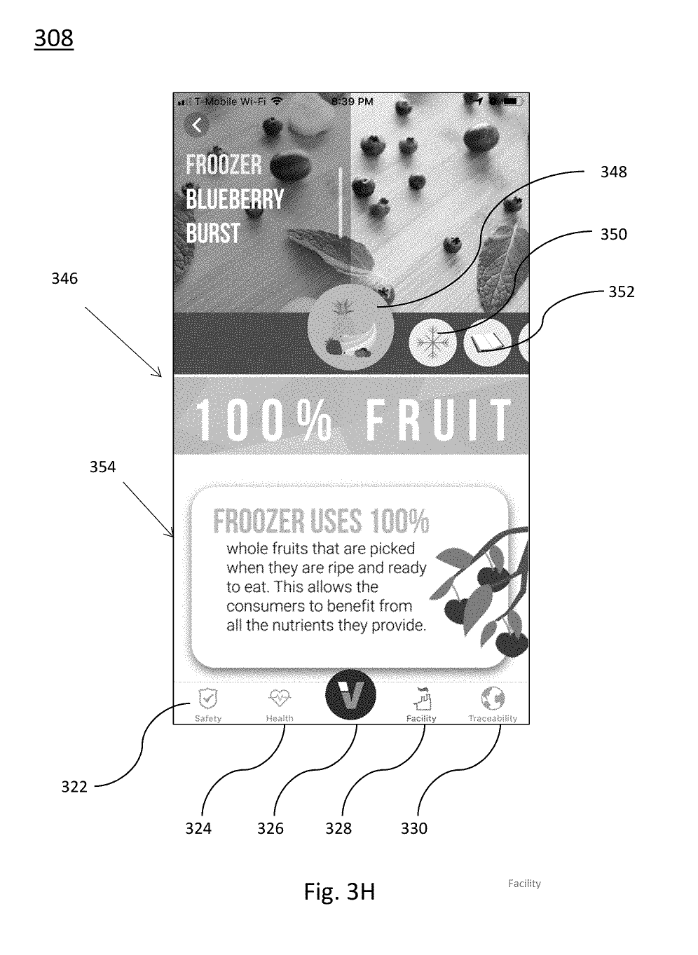

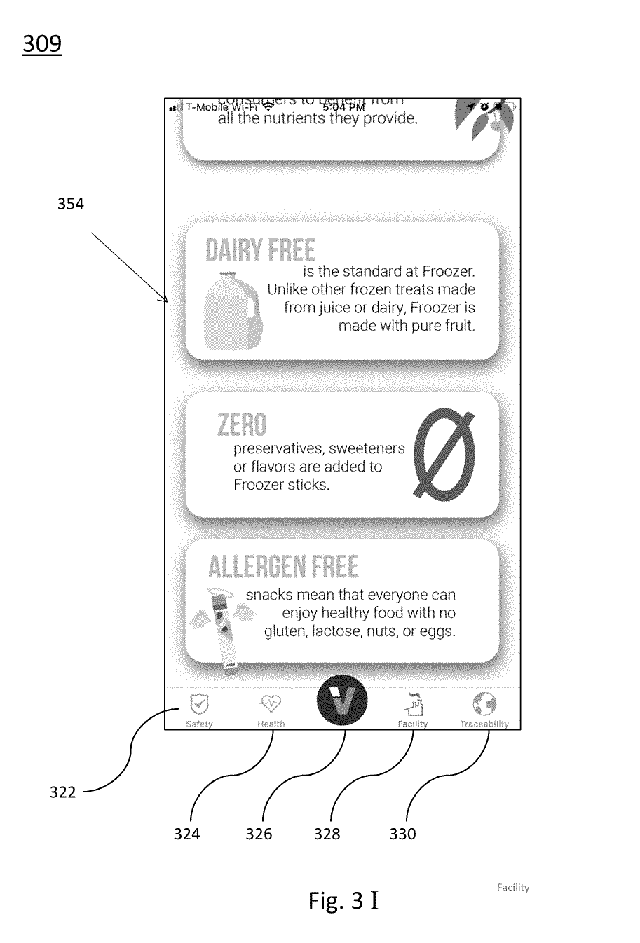

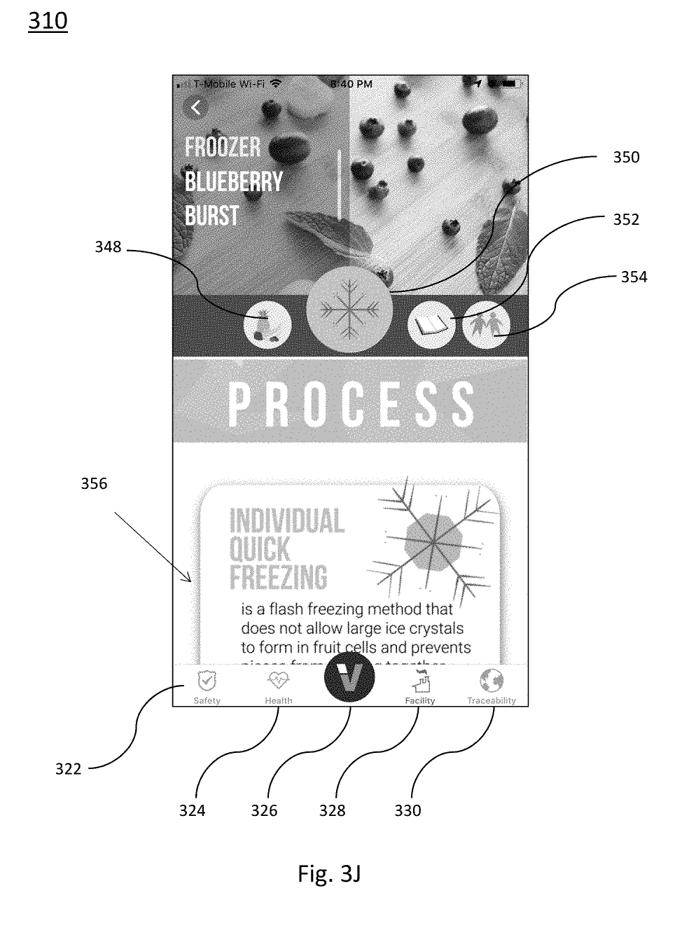

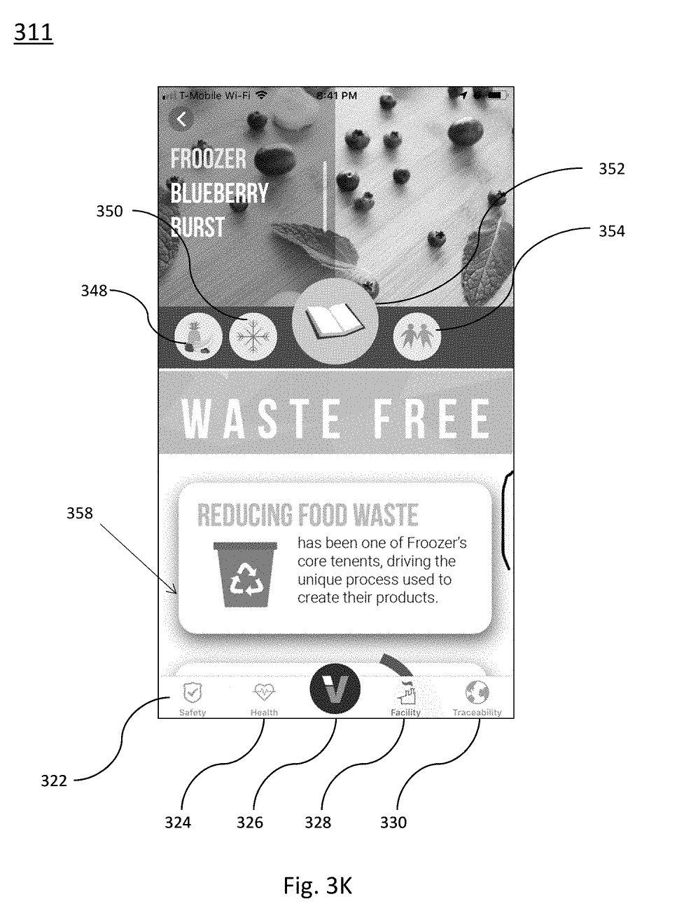

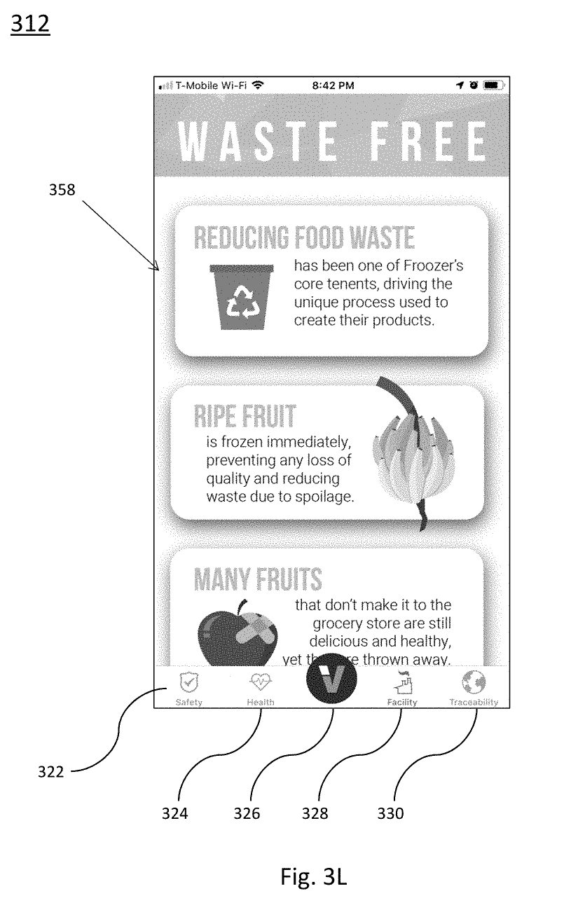

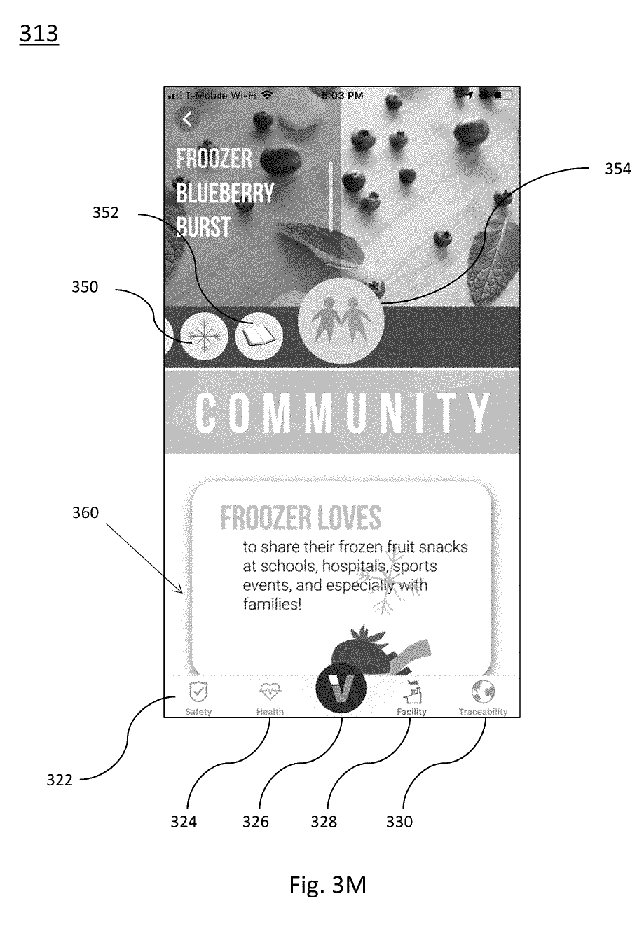

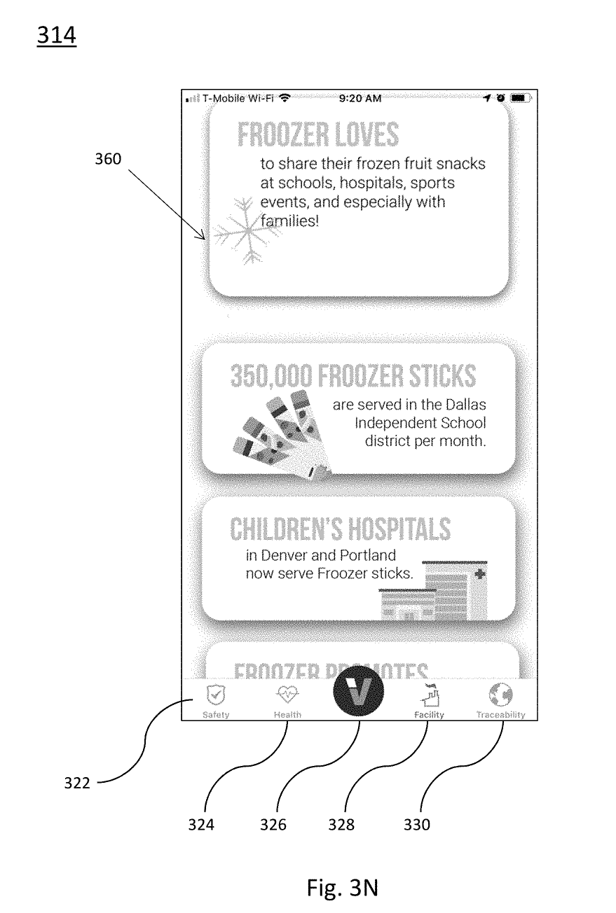

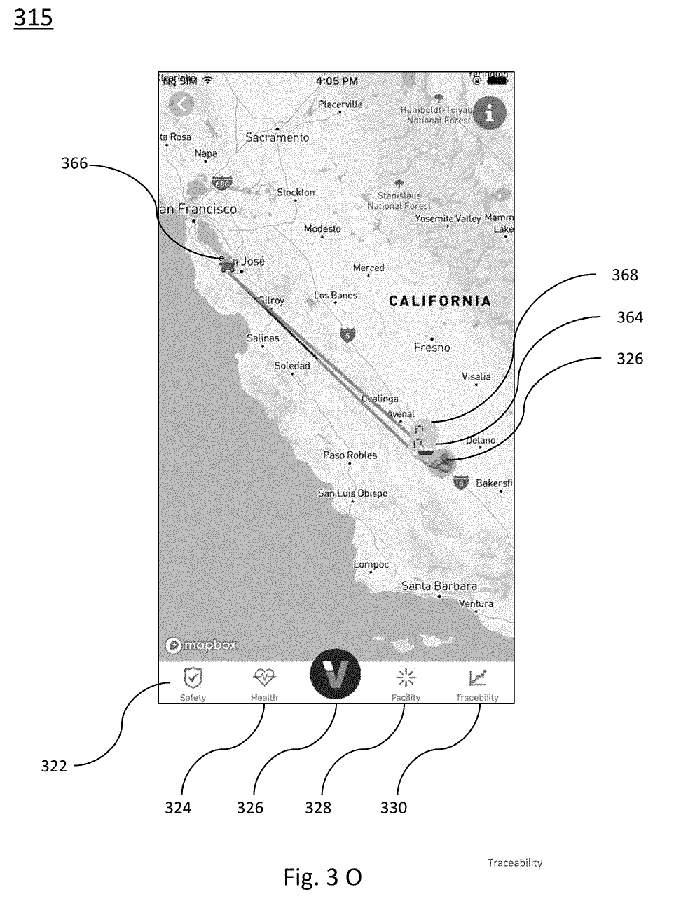

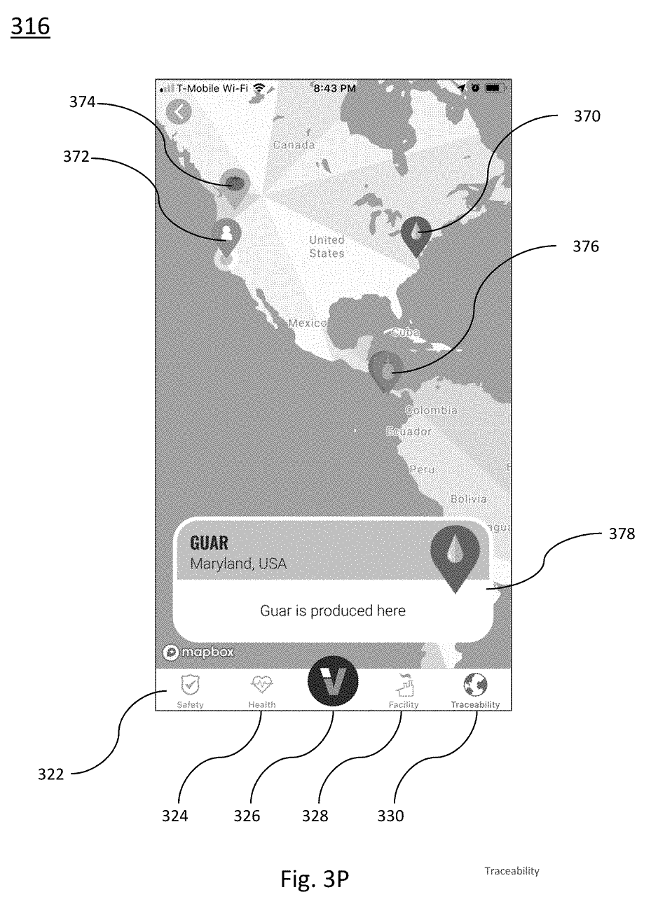

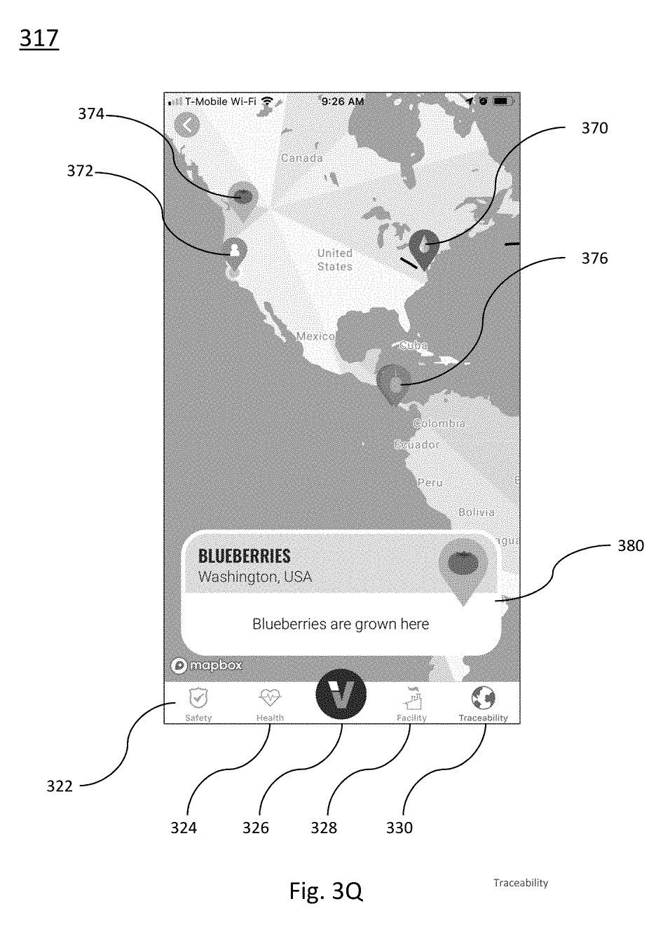

Once the food information has been received from server 102 (or retrieved through other means), computing device 106 may communicate the food information to the user. In one embodiment, food information is visually communicated via a display of computing device (i.e., one embodiment of input/output device 112). In another embodiment, food information is aurally communicated (i.e., spoken) using speakers of computing device (i.e., another embodiment of input/output device 112). It is understood that while a single input/output device 112 is depicted in FIG. 1, such input/output device 112 could represent a plurality of input/output devices (e.g., touch-screen display, keyboard, cursor-controlling device, speakers, microphone, trackpad, etc.). After the food information has been communicated to the user, the user may request additional information (e.g., more detailed information, different type of information) regarding food item 120. Such additional information may be retrieved from server 102 in a similar fashion as how the initial food information was retrieved. The specific type of food information retrieved as well as a software application for facilitating the retrieval of the food information, are described in more detail in the screenshots depicted in FIGS. 3A-3K. While the screenshots and user interfaces of FIGS. 3A-3K are those of a mobile application, it is understood that one or more of the user interfaces depicted in FIGS. 3A-3K may be adapted for display on a computer that is not running a mobile software application (e.g., a laptop/desktop computer or a desktop browser).

FIG. 3A depicts a screenshot of a landing page 301 (e.g., a user interface that may be displayed upon the launch of a software application), in accordance with one embodiment of the invention that may be displayed on a display screen, such as input/output device 112. The landing page may include a user interface element 310 (e.g., icon, button, etc.) to facilitate user operation of camera 114 in order to capture an image of food label 118. In some embodiments, a user may directly enter information and/or an identity of food item 120 for which food information is desired (e.g., brand name, product name, etc.) regarding a food item 120 and/or label 118 into landing page 301 via a text entry box 305. This may be useful when, for example, a food label 118 is missing from food item 120 and/or is damaged or not otherwise capable of being captured by camera 114 (e.g., under very low light conditions). A search may then be executed using the information input into text entry box 305.

FIG. 3B depicts a screenshot of a user interface 302 for capturing an image a food item 120 (in this case, a container of blueberry smoothie 120). In this figure, the user has centered the field of view of camera 114 about food item 120 (i.e., the blueberry smoothie container), with food label 118 (e.g., food label with characters “ESV”) not necessarily centered in the field of view. Instructions for capturing an image of food item 120 may be displayed in a message box 320 on user interface 302 to inform the user on the techniques to properly capture an image of food label 118 (e.g., Hold device 4-7″ from the ESV Label, “dim light? Try the flash”). Further, a user interface element 315 may be present to enable the user to capture the image with or without flash. Upon food label 118 appearing sufficiently clearly to computing device 106, an image of food label 118 may be automatically captured by computing device 106. Alternatively, or in addition, a user interface element (not depicted) may be present for the user to manually instruct camera 114 to capture an image of food label 118 at a certain point in time.

FIG. 3C depicts a screenshot of a user interface 303 for displaying an identity of the food item 120 depicted in an image and/or associated with a decoded food label as well as categories of food information (e.g., safety, health, facility, traceability) that may be accessed by a user, in accordance with one embodiment of the invention. The user interface of FIG. 3C may be displayed immediately after an image of food label 118 has been successfully captured. In the example of FIG. 3C, the identity of the food item (i.e., FROOZER BLUEBERY BURST), which may be have been retrieved from server 102 and/or database 125 responsively to a query including the code embedded in the imaged food label 118, may be displayed to the user. Also depicted in the user interface are icons associated with categories of food information that may be accessed by the user.

The icons provided by user interface 303 (and other user interfaces disclosed herein) are safety icon 322, health icon 324, facility icon 328, and traceability icon 330. Upon selection one of these icons, relevant and/or associated information regarding the food item associated with the imaged food label 118 may be displayed. For example, when safety icon 322 is selected, the user may receive information (e.g., see user interfaces of FIGS. 3C-3D) regarding any potential safety issues regarding, for example, microbial and/or chemical contamination that may be associated with food item 120. Upon selection health icon 324, the user may receive information (e.g., see user interfaces of FIG. 3D-3G) regarding the health benefits or adverse effects associated with food item 120. Upon selection of the facility 328, the user may receive information (e.g., see screenshot of FIGS. 3H-3N) regarding the facilities (if any) at which the food item 120 was processed, and the various measures (if any) that are in place at those facilities to ensure food safety and quality. Upon selection of the traceability icon 330, the user may receive information (e.g., see user interfaces of FIG. 3O-3Q) regarding the origins/source of the food item 120 (or its associated ingredients) and/or places of manufacturing and/or processing.

FIGS. 3C-3D depict screenshots of user interfaces 303 and 304 for displaying information regarding safety associated with the food item, in accordance with one embodiment of the invention. More particularly, user interface 303 depicts whether any bacteria (or more generally pathogens) have been detected in analyzed samples from a batch (or lot) including food item 120 via displaying a list of bacteria tested for 332 and first icon 334 that provides information indicating the food item tested negative for e. coli and second icon 336 that provides information indicating the food item tested negative for listeria. Selection of icon 334 and/or 336 may provide a window that explains the safety hazard of the particular bacteria and/or testing procedures. If not already apparent, a batch may include multiple instances of a food item manufactured or processed within a certain time period. Typical in food inspection processes, it is understood that the analysis of samples randomly selected from the batch may reveal the likelihood of safety of all food items within the batch. In the instant example, the retrieved food information (e.g., retrieved from server 102 and/or database 125) indicates that no bacteria (including salmonella, E. coli, E. coli 0157, listeria, coliform) were detected in a batch containing food item 120.

User interface 304 of FIG. D indicates whether any contaminants (such as heavy metals or pesticides) were detected in a batch containing food item 120 via list 334, which lists a variety of metal contaminants. In the instant example, lead was detected, while arsenic, cadmium and uranium were not detected. An analysis of other contaminants such a pesticides and chemicals may also be presented. An analysis of allergens (e.g., presence of peanuts for individual allergic to peanuts, presence of shellfish for individuals who may be allergic to shellfish, etc.) may also be presented. More generally, a user interface displaying the safety associated with a food item may highlight the testing performed on a food item (and/or the ingredients which are used to prepare the food item), incorporate the statistical significance associated with the testing on the food item, and describe the best practices in place to prevent the food item from becoming contaminated with harmful pathogens or substances.

In one embodiment when the user selects health icon 324 the user is directed to a screen that displays a contents list 336 and a certifications list 338 for a food item as displayed in user interface 305 FIG. 3E. In the present example, the contents of list 336 are grapes, blueberries, pineapples, bananas and guar/acacia. It is understood that processed foods, such pizza, chips, or cereal, may in general contain numerous ingredients. For some ingredients, the reason that the ingredient has been added to a food item may be provided (e.g., “added as a preservative”).

For some ingredients, certifications associated with the ingredients may be displayed in certification list 338. in the present example, the “froozer blueberry burst” food item has been certified by the “NON-GMO project”, has been certified as “kosher”, and “gluten free” (not shown). Other certifications may include “Organic”, “sustainability farmed”, “wild caught”, or “locally farmed”.

FIG. 3F depicts a user interface 306 that may be displayed upon selection of the health icon 324. User interface 306 and other interfaces displayed responsively to selection of health icon 324 may provoke display of information such as the health and nutrition facts associated with the food item. For example, FIG. 3F provides a list of health facts 340 lists the health benefits as a “mood booster, strengthen bones, improves skin, and reduce diabetes risk”, in accordance with one embodiment of the invention. In one example, when the food item is a red pepper, the health information associated with bell peppers may include “high in Vitamin C, boosts immune system health”; the wellness information associated with yogurt may include “contain pro-biotics, improves gut health”; and so on.

In accordance with one embodiment of the invention FIG. 3G depicts a screenshot of a user interface 307 for displaying information regarding the nutritional benefits of consuming the food item. The quality of a food item may include the results of testing that has been performed on the food item, shelf-life information of the food item, etc. More particularly, user interface 307 shows a table of facts (in this example, 37 calories and a serving size of 1 tube) and a series of graphics 344 that visually and textually display how many grams of fat, sugars, carbs, and proteins are present in the food item associated with an imaged food label 118.

FIGS. 3H-3N depict screenshots of user interfaces 308, 309, 310, 311, 312, 313, and 314, respectively, for displaying information regarding a production or manufacturing process for the food item that may be displayed responsively to selection of facility icon 328 and/or ingredient icon 348, in accordance with one embodiment of the invention. In the present example of a “Froozer blueberry burst” food item, the user interface of FIG. 3H provides a message bar 346 indicating the contents of the food item are “100% Fruit”, since the food item contains only blueberries and other fruits as listed in contents list 336 of FIG. 3E. User interface 308 further provides a graphic element 354 that explains a production policy of the food item manufacturer (in this case “Froozer”), the policy being the use of “whole fruits are picked when they are ripe and ready to eat. This allows the consumers to benefit from the nutrients they provide.” Such information may be for educational purposes (e.g., providing the user with a better appreciation of how the food item was farmed, prepared, etc.) and/or used to indicate that the food item complies with a user preference (e.g., only 100% fruit smoothies or only whole foods with no added sugars). In addition, or alternatively, such information may include various assessments of each stage of the production process (e.g., various quality and safety measures at each stage, information on facility cleanliness, details on an environmental monitoring program and corresponding statistical significance, information on company audits and certifications, etc.).

FIG. 3I depicts a screenshot of a user interface 354 for displaying a list 354 of information regarding various aspects of the food item (e.g., the food source is “DAIRY FREE” and the food item is processed with “ZERO preservatives, sweeteners or flavors are added . . . ” and the food source is “ALLERGEN FREE”). This information may provide the user with user information regarding the processing and safety of the food source. This information may also be useful when determining whether a food item complies with a user preference. In instances where the food item does not comply with a user preference, list 354 may visually and/or textually indicate that the food item does not comply with the preference. For example, if the food item contains peanuts and a user preference indicates the user is allergic to peanuts, then list 354 may include a warning or other statement indicating that the food item contains peanuts and/or may have been contaminated by equipment shared with peanuts.

FIG. 3J depicts a screenshot of a user interface 310 for displaying information regarding the process used in creating the food source. User interface 310 may be displayed responsively to the user selecting process icon 350. User interface 310 includes a list of processing techniques 356 and shows that the food item was processed using “individual quick freezing” with a description explaining the advantages/disadvantages of the processes for creating the food item using this process.

FIG. 3K depicts a screenshot of a user interface 311 for displaying information regarding the environmental implications of the process(es) used in creating the food source with a description explaining the advantages/disadvantages of the processes for creating the food source. User interface 311 may be displayed responsively to the user selecting book icon 352. User interface 311 includes a list 358 of environmental factors associated with the food item that allows the user to scroll the display device to reveal additional information shown in FIG. 3L, including information regarding the environmental implications on “REDUCING FOOD WASTE”, the use of “RIPE FRUIT” and information regarding reducing waste “MANY FRUITS”.

FIGS. 3M and 3N depict user interfaces 313 and 314 that provide community information that may be displayed responsively to selection of community icon 354. User interfaces 313 and 314 show a list 350 of community factors for the food source/producer that indicate, for example, a level of corporate citizenship for the company that manufactures the food source and uses of the product that benefit/harm society as a whole. User interface 360 lists facts of how the corporation contributes/detracts to/from the local/global community at large. As an exemplary example FIG. 3N depicts descriptions 360 of the manufacture “share their frozen fruit snacks at schools, hospitals, sports events and with families.”

FIG. 3O depicts a screenshot of a user interface 315 for displaying information regarding a source (e.g., location of farm, broker, processing plant, storage facility, etc.) of the food item, in accordance with one embodiment of the invention. In the example of user interface 315, the food item is almonds and the user interface of FIG. 3O depicts a map of California, revealing that the almonds were farmed at a farm near highway 5 (indicated by the a graphic element 326 showing three almonds), were then processed at two possible facilities (indicated by the two graphic elements 364 and 368 depicting a gripper arm over a conveyer belt), before finally being shipped to a storage facility near San Jose (indicated by graphic element 366 depicting a wheel barrow). While such information may be used for educational/enrichment purposes (e.g., informing the user where almonds are farmed), in other instances, such information may be used by the user to make a decision as to whether or not to purchase a food item. For instance, if a map reveals shrimp being farmed at a facility which is located next to a garbage dump, the user may decide to not purchase the shrimp.

FIGS. 3P and 3Q depict user interfaces 316 and 317, respectively. User interfaces 316 and 317 show a stylized map of portions of North and South America with graphic elements depicted therein. The graphic elements show a geographical location of particular ingredients included in a food item associated with a food label that has been imaged and decoded. More specifically, user interfaces 316 and 317 show a first graphic element 370, a second graphic element 372, a third graphic element 374, and a fourth graphic element 376. Each of the graphic elements 370, 372, 374, and 376 are superimposed on the map at, or near, a geographical location of the source for the associated ingredient. Each of the graphic elements 370, 372, 374, and 376 are user selectable so that, upon selection, a window with further information about the ingredient and the geographic location of the source is displayed. One example of such a window 378 is depicted in FIG. 3P, which shows the source for guar is Maryland, USA. Another example of such a window 380 is depicted in FIG. 3Q, which shows the source for blueberries is Washington, USA.

The information depicted in user interfaces 315-317 may be responsive to selection of traceability icon 330.

The screenshots illustrate only some aspects of the functionality of the software application that may be installed on computing device 106. In other embodiments (not depicted), a user interface may be provided for sharing recipes which may include the food item as an ingredient (e.g., a recipe for a granola bar may be provided for the food item of almonds). In other embodiments (not depicted), a user interface may be provided to allow a user to ask a nutritionist and/or a dietician on whether a food item should be consumed or how the food item is best consumed. In other embodiments (not depicted), a user interface may be provided to track whether or not a food item has been purchased (and if so, when and by whom), whether or not a food item has been consumed (and if so, when and by whom) and whether or not a food item has been discarded (and if so, when and by whom). Such information may be used by a smart refrigerator to notify users whether a food item needs to be replenished, whether a food item is nearing an expiration date, etc. Additionally, such information may be used by a manufacturer to promptly inform a user about any product recall affecting a food item that the user has purchased. Additionally, such information could also be used by manufacturers to obtain analytics in real-time for product marketing and product development activities.

While the encoded food labels may primarily be used by individual users who seek to make a better, more informed decision about the food items they purchase and consume, the encoded food labels may likewise be used by wholesale users, such as airlines, schools and university cafeterias.

In one embodiment of the invention, the user could provide certain user-specific attributes (e.g., gender=male, age range=40-50, target weight range=150-170 lbs., cholesterol target range <200 mg/dL, peanut allergies=Yes, etc.) in order to create a user profile. Based on such a user profile (which may be stored in memory 110 or in server 102), computing device 106 may provide user-specific information and suggestions. For instance, upon a user (e.g., having a user profile that indicates the presence of peanut allergies) scanning a label on a granola bar that contains peanuts, computing device 106 may display a message warning the user of the presence of peanuts in the granola bar (e.g., “WARNING: contains peanuts!”). Such message would not be displayed for a different user (e.g., having a user profile that indicates no allergies to peanuts). As another example, upon a user (e.g., having a user profile that indicates a desire to lose 10 lbs.) scanning a container of yogurt containing reduced fat, computing device 106 may display a message encouraging the user to purchase the container of yogurt (e.g., “good choice for your weight goals!”). On the other hand, such message may not be displayed for a different user (e.g., having a user profile that indicates a desire to gain 10 lbs.).

In one embodiment of the invention, computing device 106 may help users to find what they would like to purchase and consume (e.g., based on calories, fat content, gluten-free, sodium, etc.). That is, instead of simply retrieving information about a food item, the database of information about each food item may also be used to help a user identify certain food items that satisfy certain requirements. For example, in response to a user's request for gluten-free pasta, computing device 106 may search through various possible choices of pasta (i.e., stored in a database at server 102) to locate those marked as “gluten-free”, and return the selection of “gluten-free” pasta to the user.

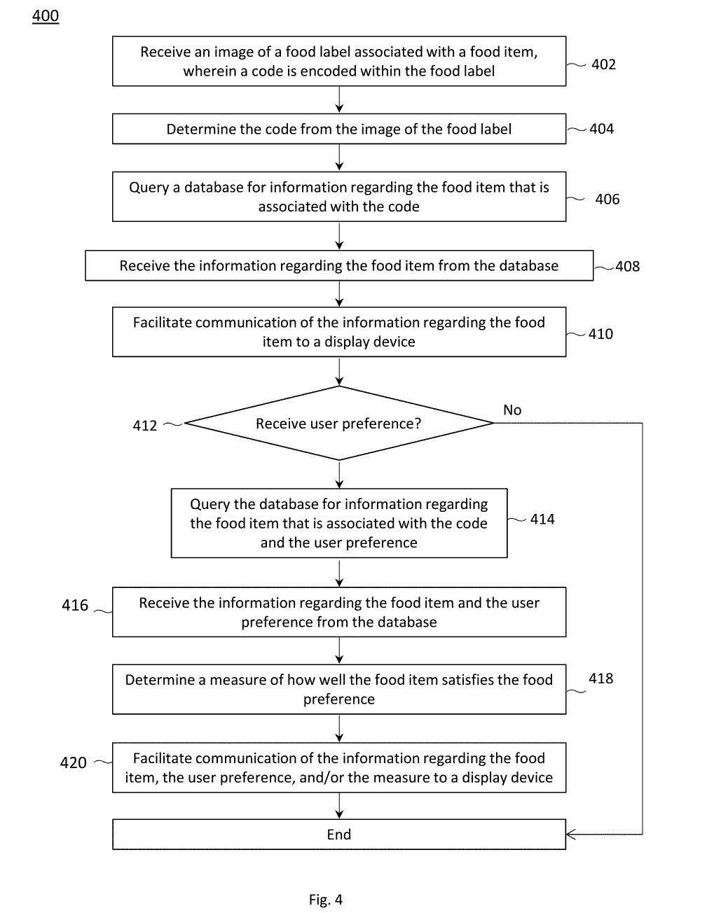

FIG. 4 depicts flowchart of a process 400 for retrieving food information from an encoded food label in accordance with one embodiment of the invention. Process 400 may be executed by, for example, a system like system 100 and/or a component or combination of components thereof.

Initially, an image of a food label affixed to a food item may be received (step 402) by, for example, a processor like processor 108 and/or computing device 106. The image may be captured by a camera like camera 114 via use of a user interface like user interface 302 of FIG. 3B, which shows an image of a container of blueberry smoothie that has a food label 118 affixed thereto. At times capturing of the image received in step 402 may be responsive to a user selecting user interface element 310 as shown in user interface 301 of FIG. 3A.

The food label may be encoded with a code that is associated with the food item via optical elements that are included in the label and the image may be of sufficient resolution to capture the optical elements. The optical elements may be so small (e.g., 1 mm-0.001 mm in width and/or length) that they are not visible to an unassisted human eye. Examples of optical elements are provided by FIG. 2B and the associated description.

At step 404, computing device 106 and/or processor 108 may determine the code (e.g., “0001010” or “AXY0172”) from the image of the food label. The code may be determined using, for example, decoding techniques appropriate to the optical elements included in the food label. For example, when the food label incorporates optical elements consistent with DWCode™ from GS1™ of Brussels, Belgium, the decoding techniques may be those specifically provided by GS1™ for the purposes of decoding optical elements consistent with the DWCode™. Additionally, or alternatively, when the food label incorporates optical elements consistent with those of the Digimarc Corporation™, the decoding techniques may be those specifically provided by Digimarc Corporation™.

At step 406, a database like database 125 and/or 135 may be queried for information regarding the food item associated with the code determined in step 404. The queried database may be, for example, database 125, database 135, and/or third-party food information source 130. Querying of database 135 may be facilitated by transceiver 116 communicating the query to server 102 via network 104. Server 102 may then submit the query to database 135, receive a response to the query and communicate the response to transceiver. When the queried database is third-party food information source 130, then the query may be communicated by transceiver 116 to server 102 and/or third-party food information source 130 via network 104. Information stored in the queried database (i.e., database 125 and/or third-party food information source 130) may be populated into the database and maintained by a third party not associated with the sale, distribution, or manufacturing of the food item, such as a third-party food safety verification entity. In some instances, the information populated into the database may be independently verified by the third party that is not directly involved in the manufacture, sale, or distribution of the food item. Exemplary third parties include, but are not limited to, food safety verification and/or auditing entities or companies.

Next, in step 408, information may be received from the database responsively to the query. Exemplary information that may be received includes, but is not limited to, food safety information that may be similar to the food safety information displayed via user interfaces 303-304, food health information that may be similar to the food health information displayed via user interfaces 305-307, food production, manufacturing, and/or distribution facility information that may be similar to the food production, manufacturing, and/or distribution facility information displayed via user interfaces 308-314 and/or food sourcing or traceability information that may be similar to the food sourcing or traceability information displayed via user interfaces 315-317.

In step 410, provision of the information received in step 408 to a display device, like input/output 112 and/or a touch screen used to display one or more user interfaces like user interfaces 303-317 may be facilitated. The information regarding the food item may include information regarding, for example, one or more of an assessment of a safety of the food item, a description of health benefits of the food item, a description of a production of the food item and a description of a source of the food item.

Optionally, in step 412, it may be determined whether a user preference and/or a request for specific information has been received and, if so, the database may be queried for information regarding the food item that is associated with the code and the user preference (step 414). A user preference/request may be received via, for example, user selection of one or more graphic elements or icons provided by user interfaces 301-317. For example, if the query includes a user request for safety information (via, for example, selection of icon 322), information regarding the safety of a food item (e.g., microbial testing, contaminant testing) may be requested from the database.

In step 416, information regarding the food item and the user preference may be received. In some embodiments, a user preference may include a request to determine a measure of how well a food item satisfies a food preference. In these embodiments, a measure of how well a food item satisfies a food preference may be determined (step 418).

Exemplary food preferences include a food allergy, a preference for organic food, a sodium content for a food item, a level of spiciness or heat associated with a food item, etc. Additionally, or alternatively, in some instances, the user preference may be a dietary preference, such as a number of calories to be consumed within a day, a maximum level of saturated fat to be consumed with an individual food item, and/or a requirement for vegan food.

For example, if the user preferences received in step 412 are 1) an allergy to peanuts and 2) a preference for mild (i.e., not spicy) food, at step 408, information regarding an exemplary food item (in this instance, blueberry smoothie) may yield receipt of an ingredient list (e.g., lentils, water, onions, and carrots; spiciness=mild, etc.). At step 418, it may be determined, based on this information, a measure of how well the food item satisfies the food preference (e.g., preference “avoid spicy foods”=satisfied, preference for peanut-free food items=satisfied). While a measure could be a binary measure (e.g., satisfied/not satisfied), a measure can also be more granular (e.g., 0=terrible, 1=tolerable, 2=ok, 3=pretty good, 4=great, 5=fantastic) or a percentage (e.g., 85% organic or 12% daily sodium allowance). In this way, the determination of 418 may be tailored/individualized to each specific user.

At step 420, communication of information regarding the food item, the user preference, and/or the measure of how well the food item satisfies the food preference (e.g., communicate “You might want to avoid this soup. It is spicy!”) may be facilitated via, for example, preparation of a display for a display device like input/output device 112. Examples of how step 420 may be performed are provided by user interfaces 303-317.

In some embodiments, process 400 may be executed a set of multiple food items, wherein each food item in the set of food items is the same. Such a request may come from, for example, a bulk purchaser of food items, a food safety auditor, and/or a distributer. When process 400 is executed this way, an image of a food label associated with a set of food items may be received. The food label may be on, for example, packaging for the set of food items, a catalog, and/or manifest. Additionally, or alternatively, food labels for each food item within the set may be identical so that the capturing of an image of one food label may be representative of all of the food labels/food items included within the set.

The food label may be encoded with a code that is associated with the set of food items, the code being encoded into the food label via optical elements that are not visible to an unassisted human eye. The image may be of sufficient resolution to capture the optical elements. The food label may be encoded with an optical code that is associated with the set of food items. The optical code may then be decoded.

A database, like database 125 and/or 135 may then be queried for information associated with at least one of the decoded optical code and the set of food items associated with the decoded optical code using, for example, an index. The queried-for information regarding the set of food items from the database may then be received and provided to a display device so that they may be communicated to a user.

In some embodiments, the information queried for and received may be of a scientific nature that may be compliant with various technical standards regarding, for example, specific testing protocols used and/or performed to assess the safety of the food items within the set of food items.

In some instances, execution of process 400 may serve to independently verify that a food item complies with one or more user preferences. This is advantageous to the user because the user knows that an independent third party has verified that the food item is compliant with his or her preference and is not reliant on the food manufacturer to provide critical information about the food item that may impact his or her health. Additionally, or alternatively, execution of process 400, or a portion thereof, may help a business concern purchase food with greater confidence because the safety of the purchased food has been verified by one or more independent third parties. Consider, for example, a restaurant purchasing food items that carry a high risk of contamination (e.g., salad ingredients or red meat), this user would benefit greatly from being able to quickly access food information though execution of process 400 prior to purchasing food items.

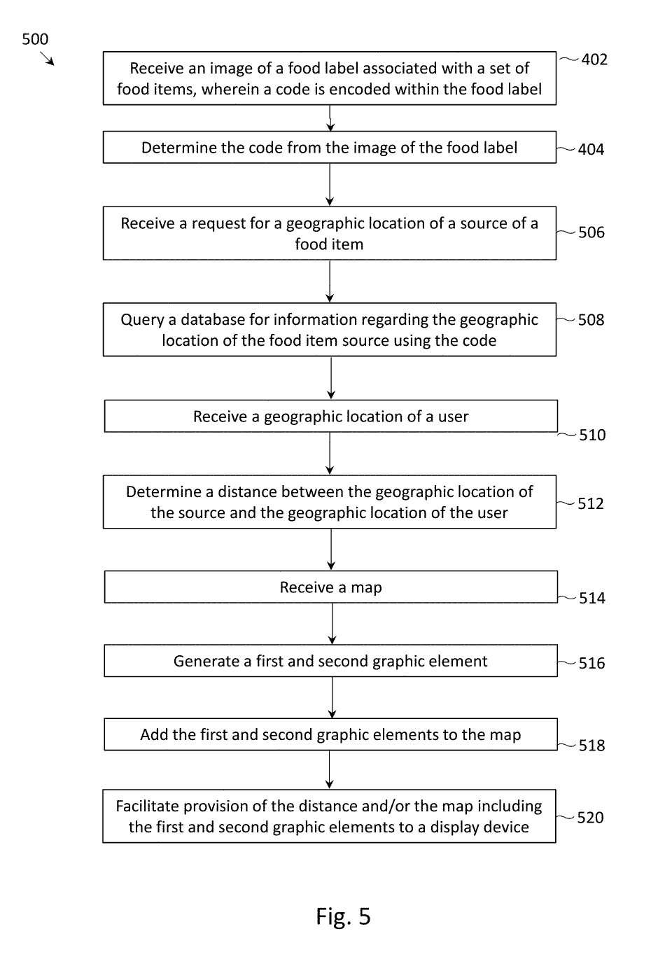

FIG. 5 provides flowchart of a process 500 for retrieving food item source information from an encoded food label in accordance with one embodiment of the invention. Process 500 may be executed by, for example, a system like system 100 and/or a component or combination of components thereof.

Initially, steps 402 and 404, as described above with regard to process 400 may be executed. Then, a request for information regarding a geographic location for a source, producer, manufacturer, and/or distributer (which may be collectively referred to herein as a “food item source” or “source”), of the food item may be received via, for example, user input received via selection of the traceability icon 330 of any of user interfaces 303-317 (step 506). A source of a food item may be, for example, where the food item is grown, harvested, or manufactured (as may be the case with chemical ingredients for food, such as vitamins or preservatives). Exemplary producers and manufactures include, but are not limited to, mills, factories, storage facilities, etc.

A database like database 125 and/or 135 may then be queried for information regarding the geographic location for the source of the food item and/or geographic location of a manufacturer of the food item (step 508). Optionally, a geographic location a user may be received (step 510). Optionally, a distance between the geographic location for the source and the geographic location of the user (step 512).

Additionally, or alternatively, in step 514, a map such as the maps shown in user interfaces 315-317, may be received and/or accessed. The map may be stored in a database like database 135 and/or 125. Then, in step a first graphic element for display on the map showing the geographic location of the source of the food item may be generated (step 516). Optionally, execution of step 516 may include generation of a second graphic element for display on the map showing the geographic location of the user. The first and optionally the second graphic elements may then be added to the map (step 518).

In step 520, the distance between the user and the source may be provided to user via, for example, providing the user with a numerical value for the distance and/or showing the distance on a may. Additionally, or alternatively, the map with the first and optionally second graphic elements may be provided to a display device (step 520).

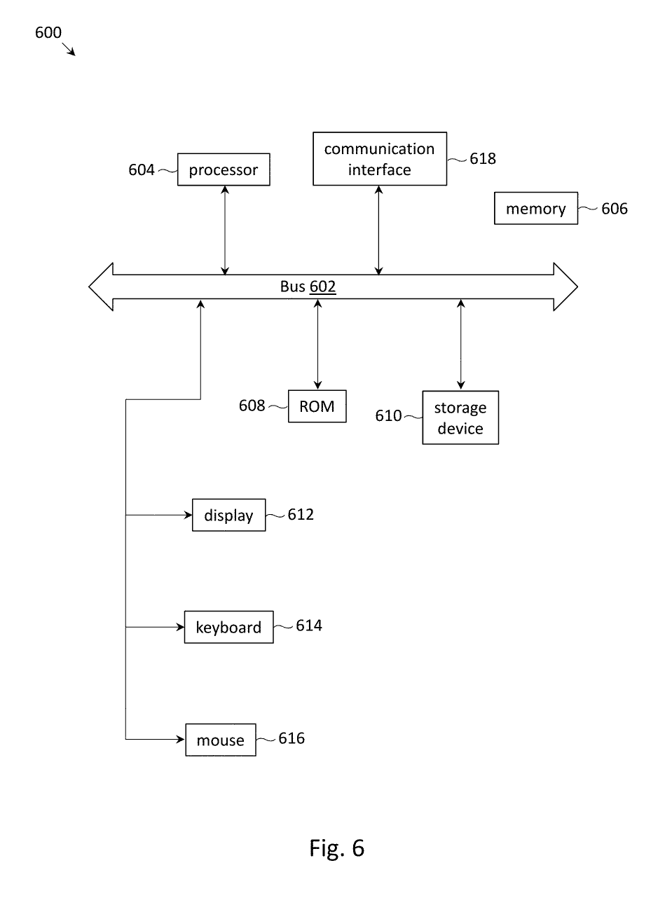

FIG. 6 provides an example of system 600 that is representative of any of computing device 106 and server 102 discussed above. Note, not all of the various processor-based systems which may be employed in accordance with embodiments of the present invention have all of the features of system 600. For example, certain processor-based systems may not include a display inasmuch as the display function may be provided by a client computer communicatively coupled to the processor-based system or a display function may be unnecessary. Such details are not critical to the present invention.

System 600 includes a bus 602 or other communication mechanism for communicating information, and a processor 604 coupled with the bus 602 for processing information. System 600 also includes a main memory 606, such as a random access memory (RAM) or other dynamic storage device, coupled to the bus 602 for storing information and instructions to be executed by processor 604. Main memory 606 also may be used for storing temporary variables or other intermediate information during execution of instructions to be executed by processor 604. System 600 further includes a read only memory (ROM) 608 or other static storage device coupled to the bus 602 for storing static information and instructions for the processor 604. A storage device 610, which may be one or more of a floppy disk, a flexible disk, a hard disk, flash memory-based storage medium, magnetic tape or other magnetic storage medium, a compact disk (CD)-ROM, a digital versatile disk (DVD)-ROM, or other optical storage medium, or any other storage medium from which processor 604 can read, is provided and coupled to the bus 602 for storing information and instructions (e.g., operating systems, applications programs and the like).

System 600 may be coupled via the bus 602 to a display 612, such as a flat panel display, for displaying information to a user. An input device 614, such as a keyboard including alphanumeric and other keys, may be coupled to the bus 602 for communicating information and command selections to the processor 604. Another type of user input device is cursor control device 616, such as a mouse, a trackball, or cursor direction keys for communicating direction information and command selections to processor 604 and for controlling cursor movement on the display 612. Other user interface devices, such as microphones, speakers, etc. are not shown in detail but may be involved with the receipt of user input and/or presentation of output.

The processes referred to herein may be implemented by processor 604 executing appropriate sequences of processor-readable instructions stored in main memory 606. Such instructions may be read into main memory 606 from another processor-readable medium, such as storage device 610, and execution of the sequences of instructions contained in the main memory 606 causes the processor 604 to perform the associated actions. In alternative embodiments, hard-wired circuitry or firmware-controlled processing units (e.g., field programmable gate arrays) may be used in place of or in combination with processor 604 and its associated computer software instructions to implement the invention. The processor-readable instructions may be rendered in any computer language.

System 600 may also include a communication interface 618 coupled to the bus 602. Communication interface 618 may provide a two-way data communication channel with a computer network, which provides connectivity to the plasma processing systems discussed above. For example, communication interface 618 may be a local area network (LAN) card to provide a data communication connection to a compatible LAN, which itself is communicatively coupled to other computer systems. The precise details of such communication paths are not critical to the present invention. What is important is that system 600 can send and receive messages and data through the communication interface 618 and in that way communicate with other controllers, etc.

Thus, methods and systems for retrieving food information from an encoded food label have been described. It is to be understood that the above-description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A method, comprising:
receiving, by a processor, an image of a food label affixed to a food item, the food label being encoded with a code that is associated with the food item, the code being encoded into the food label via optical elements that are not visible to an unassisted human eye, the image being of sufficient resolution to capture the optical elements;
analyzing, by the processor, the image to detect the optical elements and determine the code using the detected optical elements;
generating, by the processor, a query including the code;
querying, by the processor, a database for information regarding the food item that is associated with the code using the generated query;
receiving, by the processor, information from the database responsively to the query; and
facilitating, by the processor, provision of the received information to a display device.

2. The method of claim 1, wherein the information stored in the database is populated and maintained by a third party not associated with the sale, distribution, or manufacturing of the food item.

3. The method of claim 1, wherein the information stored in the database is populated, maintained, and independently verified by a third party not associated with the sale, distribution, or manufacturing of the food item.

4. The method of claim 1, wherein the food label includes at least one of a logo, text, and an image.

5. The method of claim 1, wherein the information regarding the food item includes information regarding an assessment of food item safety, a description of health impacts of the food item, a description of a production method of the food item, a description of a manufacturing process for the food item, and a description of a source of the food item.

6. The method of claim 1, wherein a portion of the information stored in the database regards the safety of the food item is verified by a third-party entity that is not involved with the sale, distribution, or manufacturing of the food item.

7. The method of claim 6, wherein food safety information pertains to at least one of a test for biological contamination of the food item and chemical contamination of the food item.

8. The method of claim 1, further comprising:
receiving, by the processor, a user selection of a category of information associated with the food item, wherein the querying is responsive to the selected category of information and the information provided to the user is responsive to the selected category of information.

9. The method of claim 1, further comprising:
receiving, by a processor, a request for information regarding a geographic location for a source of the food item;
querying, by the processor, the database for information regarding the geographic location for the source;
receiving, by the processor, the geographic location for the source responsively to the query;
receiving, by the processor, a geographic location of a user;
determining, by the processor, a distance between the geographic location for the source and the geographic location of the user;
facilitating, by the processor, provision of the distance to the display device.

10. The method of claim 9, further comprising:
receiving, by the processor, a map of a geographic region;
generating, by the processor, a first graphic element for display on the map showing the geographic location of the source of the food item;
generating, by the processor, a second graphic element for display on the map showing the geographic location of the user;
adding, by the processor, the first and second graphic elements to the map; and
facilitating, by the processor, provision of the map including the first and second elements to the display device.

11. The method of claim 1, further comprising:
receiving, by the processor, a user preference;
determining, by the processor, how the user preference applies to the information received from the database; and
facilitating, by the processor, provision of the determination to the display device.

12. The method of claim 11, wherein the user preference pertains to a food allergy and provision of the determination includes provision of a warning responsively to a determination that the information received from the database indicates that the food item may include the food allergen.

13. A method comprising:
receiving, by a processor, an image of a food label associated with a set of food items, the food label being encoded with a code that is associated with the set of food items, the code being encoded into the food label via optical elements that are not visible to an unassisted human eye, the image being of sufficient resolution to capture the optical elements, wherein each food item in the set of food items is the same;
decoding, by the processor, the optical code;
querying, by the processor, a database for information associated with at least one of the decoded optical code and the set of food items associated with the decoded optical code;
receiving, by the processor, information regarding the set of food items from the database responsively to the query; and
facilitating, by the processor, provision of the received information to a display device.

14. The method of claim 13, wherein the set of food items are manufactured by a single manufacturer.

15. The method of claim 13, wherein the information is scientific information regarding specific testing performed to assess the safety of the food items within the set of food items.

16. A non-transitory machine-readable medium comprising instructions that, when executed by a processor, cause the processor to:
receive, by a processor, an image of a food label affixed to a food item, the food label being encoded with a code that is associated with the food item, the code being encoded into the food label via optical elements that are not visible to an unassisted human eye, the image being of sufficient resolution to capture the optical elements;
analyze, by the processor, the image to detect the optical elements and determine the code using the detected optical elements;
generate, by the processor, a query including the code;
query, by the processor, a database for information regarding the food item that is associated with the code using the generated query;
receive, by the processor, information from the database responsively to the query; and
facilitate, by the processor, provision of the received information to a display device.
